(19) United States
(12) Patent Application Publication
(10) Pub. No.: US 2015/0029855 A1
(43) Pub. Date: Jan. 29, 2015

(54) TRAFFIC ROUTING

(71) Applicant: Hangzhou H3C Technologies Co., LTD., Hangzhou, Zhejiang (CN)

(72) Inventors: Guoliang Zheng, Beijing (CN); Tiezhu Gong, Beijing (CN); Haifeng Zhao, Beijing (CN)

(73) Assignee: Hangzhou H3C Technologies Co., LTD., Hangzhou, Zhejiang (CN)

(21) Appl. No.: 14/354,926

(22) PCT Filed: Dec. 21, 2012
(86) PCT No.: PCT/CN2012/087126

§ 371 Date: Apr. 28, 2014

(30) Foreign Application Priority Data
Dec. 26, 2011 (CN) 201110447763.7

(51) Int. Cl. H04L 12/803; H04L 12/707

(52) U.S. Cl. CPC H04L 47/125; H04L 45/24; H04L 45/22
USPC 370/235

(57) ABSTRACT

The present disclosure relates to a traffic routing method and a traffic routing device. A member device of a stacking system receives traffic destined for a destination node. If there is at least one valid Equal-cost multi-path (ECMP) associated with an address of the destination node in a forwarding table, the member device routes the received traffic to the destination node through the at least one valid ECMP path. Otherwise, the member device selects at least one other member device of the stacking system for routing the received traffic, updates an ECMP path associated with the address of the destination node in the forwarding table to a stacking link connecting the member device with the selected at least one member device, and transmits the received traffic to the selected at least one member device.

### BACKGROUND

In a network topology with multiple different links connected to the same destination, if data is sent to the destination via one of the links using a conventional routing technology, other links are in backup state. According to an Equal-Cost Multiple Path (ECMP) protocol, multiple links are permitted to be simultaneously used, which increases transmission bandwidth and reduces transmission delay.

### BRIEF DESCRIPTION OF THE DRAWINGS

Features of the present disclosure are illustrated by way of non-limiting examples in the following figure(s), in which like numerals indicate like elements, in which:

FIG. 1 is a schematic diagram illustrating structure of an example network with ECMP paths;

FIG. 2 is a schematic diagram illustrating structure of another example network with ECMP paths:

FIG. 3 is a schematic diagram illustrating an application mode in accordance with an example of the present disclosure;

FIG. 4 is a flow chart illustrating a traffic routing method in accordance with an example of the present disclosure;

FIG. 5 is a schematic diagram illustrating structure of a system for implementing cross-device traffic backup in accordance with an example of the present disclosure; and

FIG. 6 is a schematic diagram illustrating structure of a device in accordance with an example of the present disclosure.

### DETAILED DESCRIPTION

For simplicity and illustrative purposes, the present disclosure is described by referring mainly to non-limiting examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used throughout the present disclosure, the term “includes” means includes but not limited to, the term “including” means including but not limited to. The term “based on” means based at least in part on. In addition, the terms “a” and “an” are intended to denote at least one of a particular element.

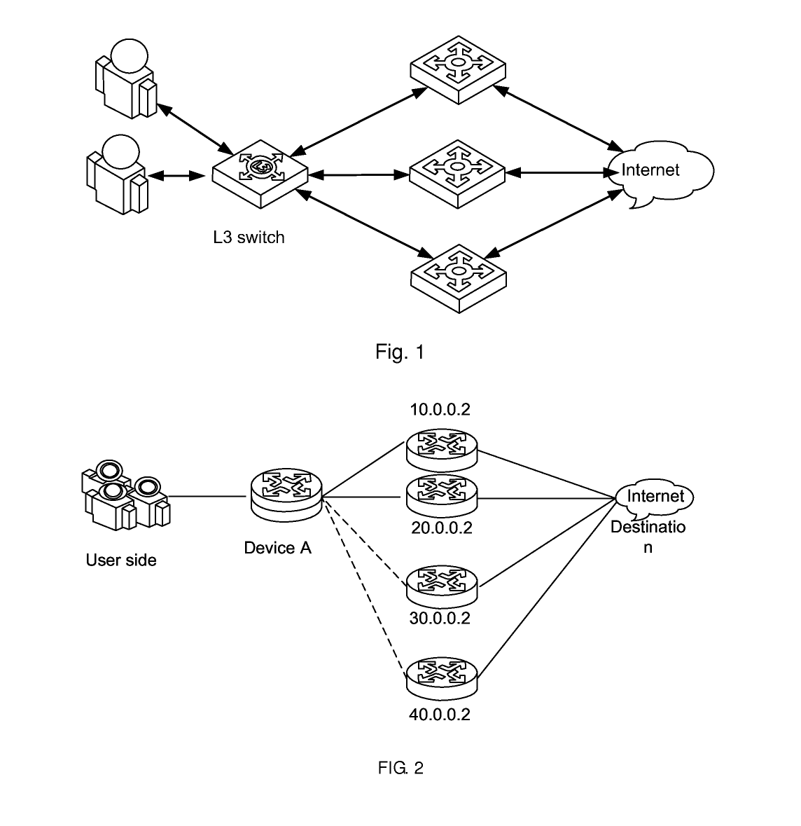

As shown in FIG. 1, there are three ECMP paths from a L3 switch to a destination node on the Internet. If any user wants to access the destination node on the Internet, the traffic generated will be load-balanced among the three ECMP paths by the L3 switch. The three ECMP paths back up each other. This way, if any of the ECMP paths fails, the traffic will be load-balanced among the other ECMP paths that are still operational.

In other words, ECMP provides multi-path load-balancing and link backup. ECMP is supported by many routing protocols, including Static Routing, Routing Information Protocol (RIP), Open Shortest Path First (OSPF) and Boader Gateway Protocol (BGP) etc.

Due to the limitations of hardware and other technologies, some network devices may support limited ECMP paths. As shown in FIG. 2, if users want to access the Internet via the device A, the device A can at best support two ECMP paths due to its hardware limitations. Therefore, in FIG. 2, although there are four ECMP paths from the device A to a destination node on the Internet, the device A selects two of the four ECMP paths, and routes the traffic to the destination node on the Internet using the selected two ECMP paths. The remaining two paths are backup paths. Therefore, the ECMP paths cannot be sufficiently used, which reduces the utilization rate of the ECMP paths.

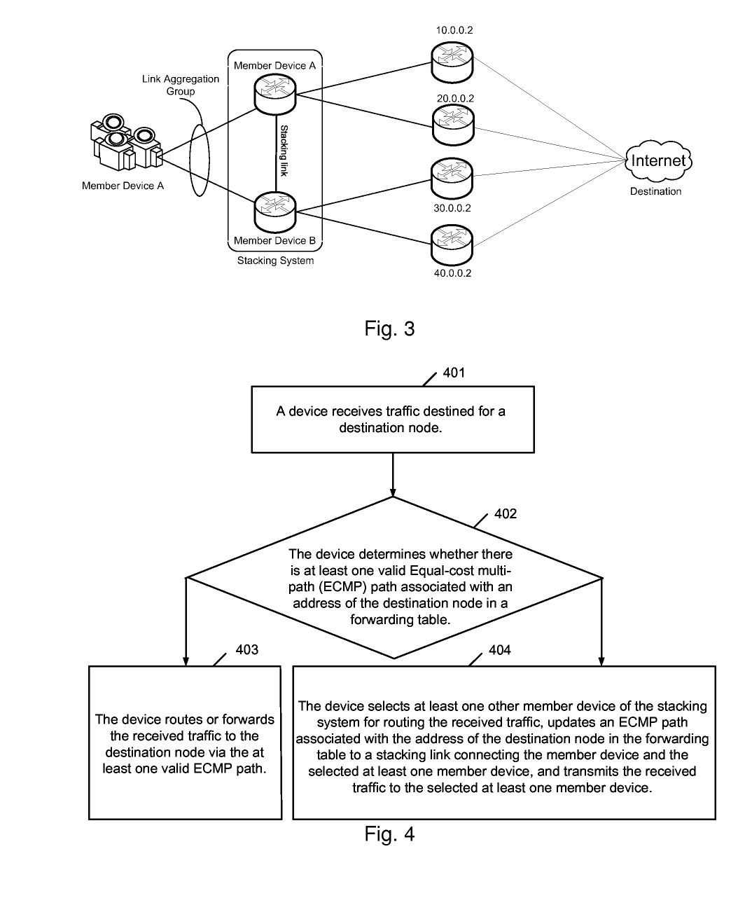

According to an example of the present disclosure, a stacking or stack system that includes multiple member devices is provided to better utilize the “backup” ECMP paths. As shown in the example in FIG. 3, the stacking system includes member device A and member device B. The user side is a previous-hop of the stacking system, and connects with the stacking system via a link aggregation group. The user side, which is configured with load-balancing mode, sends traffic destined for a destination node on the Internet to member device A and member device B in the stacking system via the link aggregation group.

FIG. 4 is a flow chart illustrating a traffic routing method in accordance with an example of the present disclosure. The method is applicable to each member device in the above stacking system. In this stacking system, the sum of ECMP paths supported by all member devices is equal to or greater than the total number of ECMP paths between the stacking system and a destination node. Each member device in the stacking system performs the following blocks.

Block 401: traffic destined for the destination node is received by a member device in the stacking system.

For example, in block 401, each member device may receive the traffic from the user side, or another member device in the stacking system.

Block 402: the member device receiving the traffic determines whether there is at least one valid ECMP path associated with an address of destination node in a forwarding table. If yes, block 403 is performed in which the received traffic is sent by the member device. If no, block 404 is performed in which the received traffic is forward to at least one other member device of the stacking system.

Block 403: the member device routes or forwards the received traffic to the destination node via the at least one valid ECMP path. If there are multiple valid paths, the traffic is forwarded by load-balancing the traffic among the valid ECMP paths associated with the address of destination node in its forwarding table.

Block 404: the member device receiving the traffic selects at least one other member device, updates an ECMP path associated with the address of the destination node in the forwarding table to a stacking link connecting the member device to the selected at least one other member device, transmits the traffic to the selected at least one other member device through the stacking link recorded in the forwarding table. The at least one member device may be selected according to ECMP routing information of all member devices in the stacking system.

In the block 404, if there is no valid ECMP path from the member device to the destination node (i.e. all the ECMP paths associated with the address of the destination node have failed or invalid), at least one member device is selected form the stacking system and used for routing the traffic. The received traffic is transmitted to the selected at least one other member device.

In other words, in the present disclosure, each member device in the stacking system preferentially routes received traffic through its own valid ECMP path(s). Each member device transmits received traffic to at least one other member device when none of its ECMP paths is valid. The purpose is to reduce the communication bandwidth load among the member devices in the stacking system.

It should be noted that in the above description, the stacking system may be implemented using any suitable system, including an Intelligent Resilient Framework (IRF) system etc. In use, there is little resemblance between the IRF and the conventional layer-3 stacking technology. In simple terms, multiple member devices supporting the IRF may interconnect with each other to form a fabric, and each device forming the fabric is also called a unit. The member devices forming the fabric appear as a whole device in terms of management and implementation. That is, the user may take the multiple member devices as a single device, manage and use the device. Thus, not only the number of ports and forwarding ability of the device can be extended by increasing the member devices, but also the reliability of the devices is enhanced through the mutual backup of the multiple devices. The method provided by FIG. 4 is described hereafter in detail taking the IRF as an example.

In FIG. 3, the member device B interconnects with the member device A through an IRF link (IRF-LINK) to form the IRF system. There are two ECMP paths from the member device A to the destination node on the Internet, with next-hop IP addresses 10.0.0.2 and 20.0.0.2 respectively. The member device B has two ECMP paths to the destination node, with next-hop IP addresses 30.0.0.2 and 40.0.0.2 respectively.

By default, the member device A and member device B configure routing information of each ECMP path in their forwarding tables. The member device A and member device B route the traffic according to the routing information in their forwarding tables.

In FIG. 3, the user side is taken as the previous hop of the stacking system. The previous hop connects with the IRF system through a group of aggregated links. The user side is configured to load-balanced between the member device A and member device B through the group of aggregated links. The hereafter description provides an example using the IRF system.

The member device A receives the traffic destined for the destination node, determines two ECMP paths with next-hop IP addresses 10.0.0.2 and 20.0.0.2 in its forwarding table are valid, load-balances the received traffic among its two ECMP paths. If it is determined that one of its the ECMP paths, for instance when the ECMP path with next-hop IP address 10.0.0.2 fails or is invalid, the member device A routes the received traffic to the destination address through the other valid ECMP path having next-hop IP address 20.0.0.2. If it is determined that none of its ECMP paths is valid, the member device A selects the member device B, transmits the received traffic to the member device B through stacking link interconnecting the member device A and the member device B. The member device B receives the traffic destined for the destination node from the member device A, and routes the traffic in place of the member device A according to the routing information in its forwarding table. Although member device A has been described above as an example, the processing process of the member device B is similar to that of the member device A.

The member device A determines at least one member device for routing the traffic in its place according to a principle of avoiding traffic loops within the stacking system, which is the IRF system in this case. The method for determining the at least one member device for routing the traffic in place of the member device A is described hereafter in detail.

To determine at least one member device for routing the traffic in place of the member device A according to the above principle, first of all, global synchronization is performed on the routing information of all the devices in the IRF system. In one example, one member device is selected as master device in the IRF system, and the other member devices are taken as slave devices. In the present disclosure, since the master device and the slave devices perform the similar operations on the forwarding plane, the member device A and member device B are not distinguished as the master device and slave device in the above description. On a control plane, the master device is responsible for global synchronization of routing information of all member devices in the IRF system. In one example method, in the initial phase, the master device obtains routing information of the ECMP paths supported by all member devices in the IRF system, and broadcasts the routing information in the IRF system. When an ECMP path supported by any member device in the IRF system fails, the member device notifies the master device of the path failure. The master device removes the failed ECMP path, and broadcasts in the IRF system to inform all the member devices that the failed ECMP path has been removed.

Since the routing information of all the member devices in the IRF is globally synchronized, the member device A determines at least one member device for routing the traffic in place of the member device A without causing traffic loops within the IRF system.

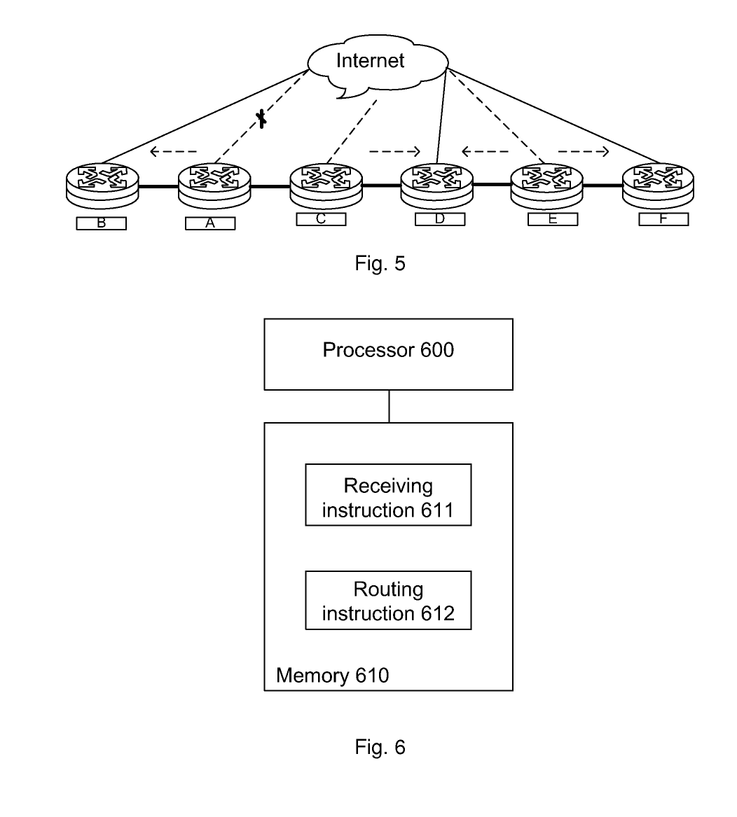

The member device A selects at least one other member device from the stacking system. The stacking link between the selected at least one other member device and member device A is the shortest stacking link and the selected member device has at least one ECMP path to the destination address. Another example of the above process is described hereafter in detail with reference to FIG. 5.

FIG. 5 is a schematic diagram illustrating structure of a stacking system for implementing cross-device traffic backup in accordance with an example of the present disclosure. As shown in FIG. 5, the stacking system includes six member devices, i.e., member device A to member device E. In order to avoid traffic loops in the stacking system due to transparent traffic transmission among the member devices, each member device in this example selects at least one other member device for routing the traffic in place of itself according to a principle of shortest path.

For instance, consider the case where all ECMP paths between the member device A and destination node on the Internet have failed and all ECMP paths from the member device C and E to the destination node have also failed. The failed or invalid links are represented using dotted lines in FIG. 5.

In this case, the member device A calculates (e.g. using SPF, which is not described in detail here) paths according to the synchronized global routing information. The calculated paths include a path to the destination address from the member device A via the member device B, a path to the destination address from the member device A via the member device D, and a path to the destination address from the member device A via the member device F.

The device A selects the shortest path from the above calculated paths. Suppose that the number of the selected shortest path is one, and the shortest path is the path via the member device B. The member device B routes the traffic in place of member device A. The member device A transmits the traffic received from the user to the member device B, the member device B balances the traffic from the user and the member device A among its valid ECMP paths.

Note that if the ECMP paths of the member device C are valid, the path to the destination from the member device A via the member device B and the path to the destination from the member device A via the member device C are shortest paths in the above calculated paths. The member device A selects the member devices B and C for routing traffic in place of itself.

Since the paths from the stacking system to the destination address are equal-cost, the paths from every member device to the destination address are equal-cost as well. Therefore, the member device A can select the shortest stacking link interconnecting itself with another member device by calculating the above shortest path.

Additionally, the member device A can select the shortest stacking link interconnecting itself with another member device having equal-cost path to the destination node based on the topology of the stacking system.

The above description illustrates how to select, by the member device A, at least one other member device for routing the traffic in place of the member device A. As an extension of the example of the present disclosure, the member device A also may select at least one other member device having the most ECMP paths for routing the traffic in place of the member device A.

It should be noted that the selection of at least one other member device for routing the traffic in place of the member device A is independent of the specific stacking topology of the devices in the stacking system, and may be applicable to different stacking typology, such as a ring stacking typology, a star stacking typology or a chain-shaped stacking typology.

When the member devices are organized as one stacking system having a star stacking typology and the member device A directly connects with one other member device, the member device A may select its directly connected member device, or select one or more member devices having the most valid ECMP paths. In the star stacking typology, other selecting criteria may be used. For instance, if multiple member devices have the most ECMP paths and one of them directly connects with the member device A, the member device A selects its directly connected member device.

If the member devices are organized as a stacking system having a ring stacking typology or chain-shaped stacking typology, the member device A may select one or two adjacent member devices on the basis of the characteristics of the ring stacking typology or the chain-shaped stacking typology. For instance, one or two devices may be selected if they have ECMP paths to the destination node. Other selecting criteria may also be used in the ring stacking typology or the chain-shaped stacking typology. For instance, the member device A selects one or more member devices having the most ECMP paths. Alternatively, the member device A may select at least one member device, which has the most ECMP paths and interconnects with the member device A with the shortest stacking link.

The member device A transmits the received traffic to the selected member device for routing the traffic in place of the member device A. The method includes the following blocks.

Block 501: It is determined whether the number of the selected at least one other member device for routing the traffic in place of the member device A is one; if yes, the block 502 is performed; if no, the block 503 is performed.

Block 502: the member device A transmits the received traffic to the selected other member device.

Block 503: the member device A calculates hash values based on traffic characteristic information, computes modulus results of the hash values modulo number of stacking links in the forwarding table, and transmits traffic to each selected member device via one stacking link matching the computed modulus result.

The traffic characteristic information may include the following information (i.e. quintuple) in IP packets of the traffic: a source IP address, a destination IP address, a source port number, a destination port number and a protocol type. Taking the number of the selected member devices as two for example, there are two stacking links associated with the address of the destination node in the forwarding table. In this case, block 503 includes: performing hash calculation based on Quintuple in IP packets of the traffic, computes a modulus result from hash values modulo 2. If the modulus result is zero, the traffic is transmitted to a member device interconnecting the member device via a stacking link matching the modulus result 0. If the result is 1, the traffic is transmitted to another selected member device via a stacking link matching the modulus result 1. This way, it can be guaranteed that the same traffic can be routed to the destination node by the same selected member device.

An example device provided by the present disclosure is described hereafter.

FIG. 6 is a schematic diagram illustrating a structure of a device for traffic routing in accordance with an example of the present disclosure. The device is a member device of a stacking system. Each member device in the stacking system supports multiple ECMP paths; the sum of ECMP paths supported by all member devices is equal to or greater than the number of ECMP paths between the stacking system and a destination node. The device shown in FIG. 6 includes a processor 600 and a memory 610.

The processor 600 communicates with the memory 610, and executes instructions stored in the memory 610.

The memory 610 includes: a receiving instruction 611 and a forwarding or routing instruction 612.

The receiving instruction 611 is to receive traffic destined for the destination node.

The routing instruction 612 is to, if there is at least one valid Equal-cost multi-path (ECMP) path associated with an address of the destination node in a forwarding table, route the received traffic to the destination node via the at least one valid ECMP path.

Otherwise, the routing instruction 612 is to select at least one other member device of the stacking system for routing the received traffic, update an ECMP path associated with the address of the destination node in the forwarding table to a stacking link connecting the member device with the selected at least one member device, and transmit the received traffic to the selected at least one member device.

The routing instruction 612 is further to select at least one other member device connecting with the member device via the shortest stacking link among other member devices having ECMP paths to the destination node in the stacking system.

The routing instruction 612 is further to select the at least one other member device connecting with the member device via the shortest stacking link among other member devices having the most ECMP paths in the stacking system.

The routing instruction 612 is further to calculate a hash value based on traffic characteristic information of the received traffic, compute a modulus result of the hash values modulo number of stacking links recorded in the forwarding table, and transmit the traffic to each selected other member device via the stacking link matching the modulus result.

According to the present disclosure, the stacking system improves the utilization rate of the ECMP paths.

The above are non-limiting examples of the disclosure. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A traffic routing method comprising:
receiving, by a member device of a stacking system, traffic destined for a destination node;
if there is at least one valid Equal-cost multi-path (ECMP) path associated with an address of the destination node in a forwarding table, routing the received traffic to the destination node through the at least one valid ECMP path;
otherwise, selecting at least one other member device of the stacking system for routing the received traffic, updating an ECMP path associated with the address of the destination node in the forwarding table to a stacking link connecting the member device with the selected at least one member device, and transmitting the received traffic to the selected at least one member device.

2. The method of claim 1, wherein selecting the at least one other member device comprises:
selecting the at least one other member device connecting with the member device via the shortest stacking link among other member devices having ECMP paths to the destination node in the stacking system.

3. The method of claim 1, wherein selecting the at least one other member device comprises:
selecting the at least one other member device connecting with the member device via the shortest stacking link among other member devices having the most ECMP paths to the destination node in the stacking system.

4. The method of claim 1, wherein transmitting the traffic to the selected at least one other member device comprises:
calculating a hash value based on traffic characteristic information of the received traffic, computing a modulus result of the hash value modulo number of stacking links recorded in the forwarding table, and transmitting the traffic to each selected other member device via the stacking link matching the modulus result.

5. A traffic routing device capable of acting as a member device of a stacking system, wherein the device comprises: a memory and a processor to execute instructions stored in the memory to:
receive, by a member device of a stacking system, traffic destined for a destination node;
if there is at least one valid Equal-cost multi-path (ECMP) path associated with an address of the destination node in a forwarding table, route the received traffic to the destination node through the at least one valid ECMP path;
otherwise, select at least one other member device of the stacking system for routing the received traffic, update an ECMP path associated with the address of the destination node in the forwarding table to a stacking link connecting the member device with the selected at least one member device, and transmit the received traffic to the selected at least one member device.

6. The device of claim 5, wherein the processor is further to select at least one other member device connecting with the member device via the shortest stacking link among other member devices having ECMP paths to the destination node in the stacking system.

7. The device of claim 5, wherein the processor is further to select the at least one other member device connecting with the member device via the shortest stacking link among other member devices having the most ECMP paths in the stacking system.

8. The device of claim 5, wherein the processor is further to calculate a hash value based on traffic characteristic information of the received traffic, compute a modulus result of the hash values modulo number of stacking links recorded in the forwarding table, and transmit the traffic to each selected other member device via the stacking link matching the modulus result.
